(19) United States
(12) Patent Application Publication
(10) Pub. No.: US 2010/0143863 A1
(43) Pub. Date: Jun. 10, 2010

(54) Dental cleaning device

(76) Inventor: Szu Teng Lin, Changhua (TW)

Correspondence Address: CHARLES E. BAXLEY, ESQUIRE, 90 JOHN STREET, SUITE 309, NEW YORK, NY, 10038, US

(21) Appl. No.: 12/316,138

(22) Filed: Dec. 10, 2008

(51) Int. Cl. A61C 17/00

(52) U.S. Cl. 433/87

(57) ABSTRACT

A dental cleaning device includes a mouthpiece having an arcuately shaped casing pivotally coupled to a housing and having two opposed channels formed in the casing and arranged back-to-back, and sharing a common horizontal web for receiving teeth of a user and for receiving a water, and one or more vibrating devices, such as supersonic vibrating devices are engaged into the casing for vibrating the water to clean the teeth of the user without bristles or brushes, and for preventing the teeth of the user from being scraped or scrubbed by the bristles or brushes. A container is attached to the housing for receiving and supplying the water to the mouthpiece.

### BACKGROUND OF THE INVENTION

1. Field of the Invention

The present invention relates to a dental cleaning device, and more particularly to a dental cleaning device including an ultrasonic vibrating device for agitating the water and for generating air bubbles to suitably clean the teeth of the user without bristles or brushes and for preventing the teeth of the user from being scraped or scrubbed and damaged by the bristles or brushes.

2. Description of the Prior Art

Typical dental cleaning devices comprise an arcuately shaped portion of resilient material which is of a size and shape to conform to the line of teeth of the user when the user bites down onto the resilient and arcuately shaped portion.

For example, U.S. Pat. No. 3,769,652 to Rainer, and U.S. Pat. No. 3,874,084 to Cole disclose two of the typical chewing toothbrushes and each comprising an arcuately shaped portion of resilient material which includes a pair of integral channels having a size and shape to conform to the maxillary and mandibular arches respectively, and to the arcuate arrangement of the teeth and surrounding structures within the mouth of the user when the user bites down onto the resilient and arcuately shaped portion.

However, the user should move his teeth relative to the bristles or brushes of soft, elastomeric material which scrub the surfaces and interstices of the teeth at the user chews on the resilient and arcuately shaped portion, such that the teeth of the user will be scraped or scrubbed and damaged by the bristles or brushes after use.

U.S. Pat. No. 4,011,616 to Kennedy discloses another typical teeth cleaning device also comprising a soft shoe bristled on one side and having a metal structural skeleton, and the shoe is capable of being formed over a human dental arch so that the bristles will be in contact with the teeth, and a vibrating apparatus is coupled to the horseshoe-shaped base or to the brush for moving the bristles relative to the teeth of the user in order to scrape or scrub the teeth of the user.

However, the teeth of the user will also be scraped or scrubbed and damaged by the bristles or brushes when the bristles or brushes are moved automatically by the vibrating apparatus.

U.S. Pat. No. 5,175,901 to Rabinowitz discloses a further typical teeth brushing device also comprising a resilient U-shaped housing containing a channel within which the arch of teeth fits, and a plurality of bristles substantially covers the surface area of the channel for engaging into the teeth at the user and for suitably cleaning the teeth of the user with the bristles or brushes when the user bites down onto the resilient and arcuately shaped housing of the typical teeth brushing device.

However, similarly, the user should move his teeth relative to the bristles or brushes which scrub the surfaces and interstices of the teeth at the user chews on the resilient and arcuately shaped housing, such that the teeth of the user will also be scraped or scrubbed and damaged by the bristles or brushes after use.

The present invention has arisen to mitigate and/or obviate the afore-described disadvantages of the conventional dental cleaning devices.

### SUMMARY OF THE INVENTION

The primary objective of the present invention is to provide a dental cleaning device having no bristles or brushes for preventing the teeth of the user from being scraped or scrubbed by the bristles or brushes.

The other objective of the present invention is to provide a dental cleaning device including an ultrasonic vibrating device for agitating the water and for generating air bubbles to suitably clean the teeth of the user without bristles or brushes.

In accordance with one aspect of the invention, there is provided a dental cleaning device comprising a housing, a mouthpiece including an arcuately shaped casing pivotally coupled to the housing, and including two opposed channels formed in the casing and arranged back-to-back, and sharing a common horizontal web for receiving teeth of a user and for receiving a water, and one or more vibrating devices, such as supersonic vibrating devices engaged into the casing for vibrating the water to clean the teeth of the user without bristles or brushes.

The mouthpiece includes a passage formed in the casing and communicating with the channels of the casing for supplying the water into the channels of the casing and for allowing the water to contact with the teeth of the user.

The casing includes an orifice formed in the middle portion of the web and communicating with the channels of the casing for allowing the water to flow from the orifice into both of the channels of the casing.

The casing includes a space for receiving the vibrating device, and an aperture formed in casing and communicating with the space and the channels of the casing for allowing the water to be agitated by the vibrating device, and the vibrating device is preferably coated with a protective outer coating for preventing the vibrating device from being contacted with the water and for preventing the vibrating device from being rusted by the water.

The housing includes a circuit board having a switch button extended out of the housing and arranged for being depressed or actuated by the user, and the circuit board is electrically coupled to the vibrating device for controlling the vibrating device to vibrate or agitate the water.

A power device is further provided and electrically coupled to the circuit board for supplying an electric energy to the circuit board and the vibrating device.

An electric cable is further provided and electrically coupled to the power device and includes a lower portion for selectively and electrically coupling to a charging device.

A container is further provided and attached to the housing and includes a compartment formed therein for receiving the water, and a hose includes a lower portion engaged into the compartment of the container and includes an upper portion engaged into the casing for supplying the water from the compartment of the container into the channels of the casing.

A pump is further provided and disposed in the compartment of the container and/or coupled to the hose for pumping and supplying the water from the compartment of the container into the channels of the casing.

A check valve is further provided and disposed in the hose for limiting the water to flow from the compartment of the container into the channels of the casing and for preventing the water from flowing back from the mouthpiece into the compartment of the container.

The casing includes two base members arranged back-to-back and secured together for forming the web between the base members, and the channels are formed in the base members for receiving the teeth of the user.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a dental cleaning device in accordance with the present invention;

FIG. 2 is a partial exploded view of the dental cleaning device;

FIG. 3 is a partial perspective view illustrating an arcuately shaped shoe or housing of the dental cleaning device;

FIG. 4 is a cross sectional view of the dental cleaning device taken along lines 4-4 of FIG. 1;

FIG. 5 is a partial side plan schematic view of the dental cleaning device, in which a portion of the dental cleaning device has been cut off for showing an inner structure of the arcuately shaped shoe or housing of the dental cleaning device; and

FIG. 6 is a side plan schematic view of the dental cleaning device, in which a portion of the dental cleaning device has been cut off for showing an inner structure of the dental cleaning device for illustrating the operation of the dental cleaning device.

### DETAILED DESCRIPTION OF THE PREFERRED EMBODIMENT

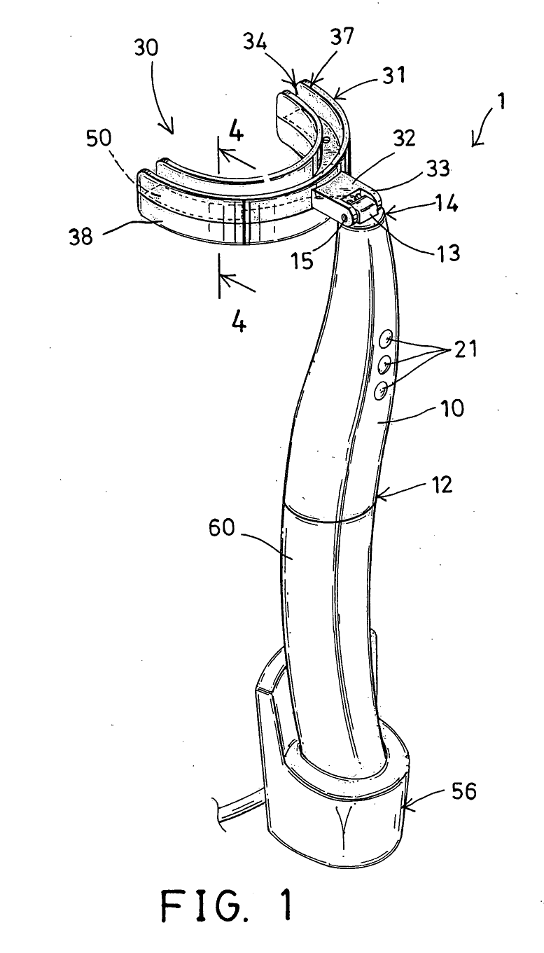

Referring to the drawings, and initially to FIGS. 1-2, and 6, a dental cleaning device 1 in accordance with the present invention comprises a handle or housing 10 including a chamber 11 formed therein, and including an open bottom portion 12, and including a seat 13 extended upwardly from the upper portion 14 of the housing 10, and including an axle 15 laterally extended from the seat 13. A circuit board 20 is disposed in the chamber 11 of the housing 10 and includes one or more switch buttons 21 extended out of the housing 10 for being depressed or actuated or operated by the user.

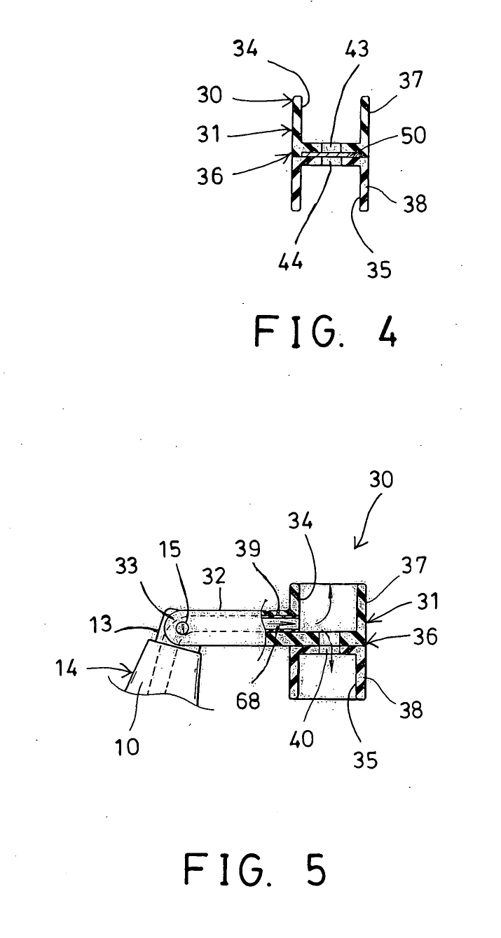

A mouthpiece 30 includes an arcuately shaped casing 31, and includes a protrusion 32 extended from the casing 31, such as extended from the middle portion of the casing 31, and having two ears 33 extended from the protrusion 32 for pivotally or rotatably coupling to the seat 13 of the housing 10 with the axle 15 and for allowing the casing 31 to be pivoted or rotated relative to the housing 10. The casing 31 may include an H-shaped cross section (FIGS. 4-6) with two opposed channels 34, 35 arranged back-to-back, and sharing a common horizontal web 36 which forms the bottom of both channels 34, 35.

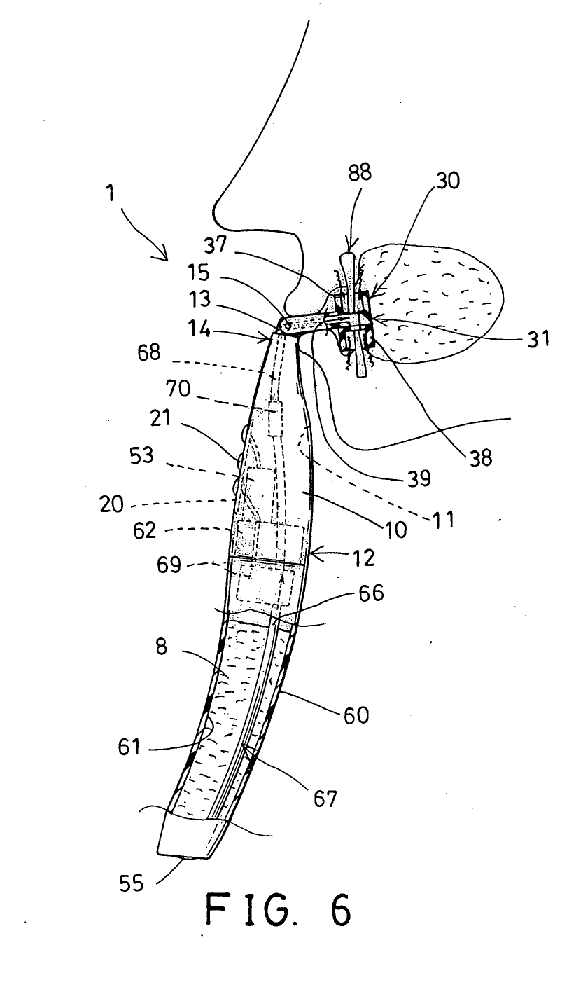

As shown in FIG. 1, the casing 31 of the mouthpiece 30 is preferably made of soft, resilient rubber or plastic or elastomeric materials, such as polyethylene, and may include two arcuately and U-shaped base members 37, 38 arranged back-to-back and secured together with supersonic welding processes, or adhesive materials, for example, and having the common horizontal web 36 formed between the base members 37, 38. The channels 34, 35 and the base members 37, 38 are of a size and shape to conform to the line of teeth 88 (FIG. 6) of the user when the user bites down onto the resilient and arcuately shaped base members 37, 38 of the casing 31.

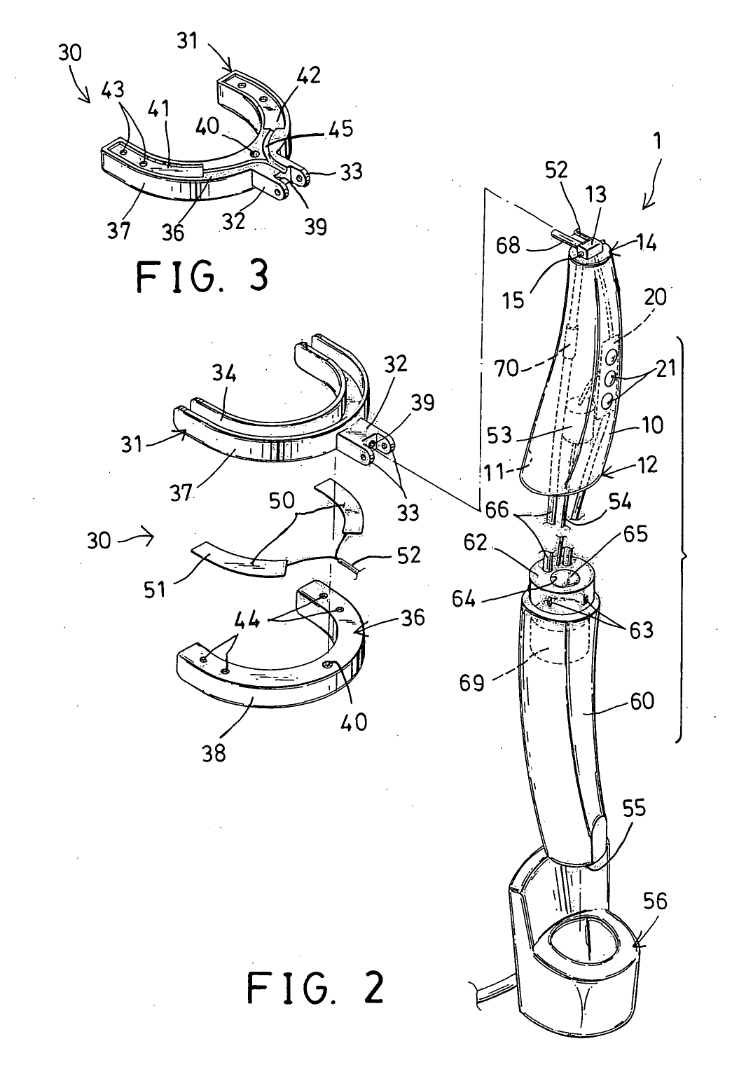

The casing 31 includes a passage 39 formed through the protrusion 32 (FIGS. 2-3, 5-6) and communicating with one of the channels 34 of the casing 31 for allowing the water to be supplied into the channel 34 of the casing 31, and includes an orifice 40 formed in the middle portion of the web 36 of the casing 31 and communicating with the channels 34, 35 for allowing the water to flow into both of the channels 34, 35 of the casing 31, and for allowing the water to contact and to suitably clean the teeth 88 of the user that are received or engaged in the channels 34, 35 of the casing 31.

The casing 31 may include two recesses or spaces 41, 42 formed in one of the base members 37 and formed in the end portions of the web 36 of the casing 31 (FIG. 3), and each for receiving a conductor or ultrasonic vibrating device 50 therein, and includes one or more apertures 43, 44 formed in each of the base members 37, 38 and communicating with the spaces 41, 42 of the casing 31 for allowing the water received in the channels 34, 35 of the casing 31 to be vibrated or agitated by the vibrating devices 50, in which the vibrating devices 50 are preferably coated with a protective outer coating 51 for preventing the vibrating devices 50 from being contacted and rusted by the water.

The casing 31 may further include a Y-shaped pathway 45 formed in the middle portion of the web 36 of the casing 31 (FIG. 3) and communicating with the spaces 41, 42 of the casing 31, and also formed through the protrusion 32 of the casing 31 for receiving an electric wire or cable 52 which is electrically coupled to the circuit board 20 and also electrically coupled to the vibrating devices 50 for allowing the vibrating devices 50 to be actuated or operated by the switch buttons 21 of the circuit board 20. A power device 53, such as a rechargeable battery 53 is disposed in the chamber 11 of the housing 10 and electrically coupled to the circuit board 20 for supplying the electric energy to the circuit board 20 and/or the vibrating devices 50.

The dental cleaning device 1 further includes a container 60 having a compartment 61 formed therein for receiving the water 8, and includes a projection 62 extended upwardly therefrom for engaging into the open bottom portion 12 of the housing 10 (FIG. 6) and for attaching or securing the container 60 to the bottom portion 12 of the housing 10 with a force-fitted engagement, adhesive materials, or with supersonic welding processes, the container 60 may include one or more catches 63 extended radially and outwardly therefrom for engaging with the housing 10 and for attaching or securing the container 60 to the housing 10.

The container 60 may include an inlet 64 formed in the upper portion thereof and formed through the projection 62 (FIG. 2) for filling the water 8 into the compartment 61 of the container 60, and a cap 65 for openably blocking or sealing the inlet 64 of the container 60, and a hose 66 is disposed in the chamber 11 of the housing 10 and includes a lower portion 67 engaged into the compartment 61 of the container 60, and includes an upper portion 68 extended out of the housing 10 (FIG. 2) and engaged into the passage 39 of the casing 31 for supplying the water 8 from the compartment 61 of the container 60 into the channels 34, 35 of the casing 31. The lower portion 67 of the hose 66 may also be directly coupled to a water source or faucet (not shown) or the like.

A pump 69 is disposed in the compartment 61 of the container 60, and/or coupled to the hose 66 for pumping the water 8 from the compartment 61 of the container 60 into the channels 34, 35 of the casing 31, and a check valve 70 may be disposed in the upper portion 68 of the hose 66 for limiting the water 8 to flow from the compartment 61 of the container 60 into the channels 34, 35 of the casing 31, and to prevent the water 8 from flowing back into the compartment 61 of the container 60. The pump 69 is electrically coupled to the circuit board 20 and/or the power device 53 for being energized by the power device 53 and controlled with the switch buttons 21 of the circuit board 20.

As shown in FIG. 2, another electric wire or cable 54 is electrically coupled to the power device 53 and/or the rechargeable battery 53, and includes a lower portion 55 extended out of the container 60 (FIGS. 2, 6) for selectively and electrically coupling to a charging device 56 which may charge the power device 53 and/or the rechargeable battery 53 selectively, and the power device 53 and/or the rechargeable battery 53 may then be used to supply the electric energy to the circuit board 20 and/or the vibrating devices 50 and/or the pump 69.

In operation, as shown in FIG. 6, when the teeth 88 of the user bites down onto the resilient and arcuately shaped base members 37, 38 and into the channels 34, 35 of the casing 31, the switch buttons 21 of the circuit board 20 may be depressed or actuated or operated by the user in order to actuate or operate the pump 69 and to pump the water 8 from the compartment 61 of the container 60 into the channels 34, 35 of the casing 31, the vibrating devices 50 may then be actuated or operated automatically, or actuated or operated with the switch buttons 21 of the circuit board 20 to agitate or vibrate the water and to generate air bubbles in the water and to suitably clean the teeth 88 of the user without bristles or brushes and for preventing the teeth 88 of the user from being scraped or scrubbed by the bristles or brushes.

Accordingly, the dental cleaning device in accordance with the present invention includes an ultrasonic vibrating device for agitating the water and for generating air bubbles to suitably clean the teeth of the user without bristles or brushes and for preventing the teeth of the user from being scraped or scrubbed by the bristles or brushes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A dental cleaning device comprising:
a housing,
a mouthpiece including an arcuately shaped casing pivotally coupled to said housing, and including two opposed channels formed in said casing and arranged back-to-back, and sharing a common horizontal web for receiving teeth of a user and for receiving a water, and
at least one vibrating device engaged into said casing for vibrating the water to clean the teeth of the user.

2. The dental cleaning device as claimed in claim 1, wherein said mouthpiece includes a passage formed in said casing for supplying the water into said channels of said casing and for allowing the water to contact with the teeth of the user.

3. The dental cleaning device as claimed in claim 1, wherein said casing includes an orifice formed in said web and communicating with said channels of said casing for allowing the water to flow into both of said channels of said casing.

4. The dental cleaning device as claimed in claim 1, wherein said casing includes a space for receiving said at least one vibrating device, and an aperture formed in casing and communicating with said space and said channels of said casing for allowing the water to be agitated by said vibrating device.

5. The dental cleaning device as claimed in claim 1, wherein said housing includes a circuit board having a switch button for being actuated by the user, and said circuit board is electrically coupled to said vibrating device.

6. The dental cleaning device as claimed in claim 5, wherein a power device is electrically coupled to said circuit board for supplying an electric energy to said circuit board and said at least one vibrating device.

7. The dental cleaning device as claimed in claim 6, wherein an electric cable is electrically coupled to said power device and includes a lower portion for selectively and electrically coupling to a charging device.

8. The dental cleaning device as claimed in claim 1, wherein a container is attached to said housing and includes a compartment formed therein for receiving the water, and a hose includes a lower portion engaged into said compartment of said container and includes an upper portion engaged into said casing for supplying the water from said compartment of said container into said channels of said casing.

9. The dental cleaning device as claimed in claim 8, wherein a pump is disposed in said compartment of said container for pumping the water from said compartment of said container into said channels of said casing.

10. The dental cleaning device as claimed in claim 8, wherein a check valve is disposed in said hose for limiting the water to flow from said compartment of said container into said channels of said casing.

11. The dental cleaning device as claimed in claim 1, wherein said casing includes two base members arranged back-to-back and secured together, and said channels are formed in said base members.
